(19) United States
(12) Patent Application Publication
(10) Pub. No.: US 2015/0356967 A1
(43) Pub. Date: Dec. 10, 2015

(54) Generating Narrative Audio Works Using Differentiable Text-to-Speech Voices

(71) Applicant: International Business Machines Corporation, Armonk, NY (US)

(72) Inventors: Donna K. Byron, Petersham, MA (US); Alexander Pikovsky, Lexington, MA (US); Eric Woods, Durham, NC (US)

(21) Appl. No.: 14/298,941

(22) Filed: Jun. 8, 2014

(51) Int. Cl. G10L 13/033; G10L 13/08

(52) U.S. Cl. CPC G10L 13/033; G10L 13/08

(57) ABSTRACT

An approach is provided in which a voice management system generates multiple audio test recordings using multiple text-to-speech (TTS) voices that have different acoustic properties. The voice management system determines that a comparison between a first one of the TTS voices and a second one of the TTS voices reaches an acoustic differentiation threshold and, as a result, assigns the first TTS voice to a first character and assigns the second TTS voice to a second character. In turn, the voice management system generates a narrative audio work utilizing the first TTS voice corresponding to the first character and the second TTS voice corresponding to the second character.

### BACKGROUND

The present disclosure relates to generating narrative audio works using differentiable text-to-speech voices.

A listener of an audio rendition of a narrative work easily follows the narrative work's storyline when the narrator and characters have distinguishable voices. When human actors use their voices to portray characters to create audio books, the audio books naturally produce differing voice attributes that include differing accents, pitch ranges, speaking styles, tempos, and et cetera. As such, the listener recognizes when particular characters are speaking in the narrative audio work.

However, when an audio rendition of a narrative work uses synthetic voices generated from a speech synthesis system, the various characters within a narrative audio work may have non-differentiating vocal characteristics. Text-to-speech technology enables a computer system to “speak” text-based material using an artificial representation of human speech. A TTS system typically includes a front-end segment and a back-end segment. The front-end segment converts raw text that includes symbols, numbers, and abbreviations into word equivalents. The front-end section then assigns phonetic transcriptions to each word and divides the text into prosodic units, such as phrases, clauses, and sentences, typically referred to as a text-to-phoneme conversion or a grapheme-to-phoneme conversion.

The back-end section, in turn, converts the prosodic units into sound according to a selected TTS voice speaker profile (old man, young woman, etc.). When a narrative audio work includes several characters having similar speaker profiles, the narrative audio work may utilize similar TTS voices for different characters that are not distinguishable to a listener.

### BRIEF SUMMARY

According to one embodiment of the present disclosure, an approach is provided in which a voice management system generates multiple audio test recordings using multiple text-to-speech (TTS) voices that have different acoustic properties. The voice management system determines that a comparison between a first one of the TTS voices and a second one of the TTS voices reaches an acoustic differentiation threshold and, as a result, assigns the first TTS voice to a first character and assigns the second TTS voice to a second character. In turn, the voice management system generates a narrative audio work utilizing the first TTS voice corresponding to the first character and the second TTS voice corresponding to the second character.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present disclosure, as defined solely by the claims, will become apparent in the non-limiting detailed description set forth below.

### BRIEF DESCRIPTION OF THE SEVERAL VIEWS OF THE DRAWINGS

The present disclosure may be better understood, and its numerous objects, features, and advantages made apparent to those skilled in the art by referencing the accompanying drawings, wherein:

FIG. 1 is an exemplary diagram showing one example of a voice management system that assigns distinguishable text-to-speech (TTS) voices to speakers to generate a narrative audio work;

FIG. 2 is an exemplary diagram depicting one example of an assignment table that includes initial voice assignments of various speakers;

FIG. 3 is an exemplary diagram depicting one example of an assignment table that includes revised voice assignments of various speakers;

FIG. 4 is an exemplary flowchart showing one example of steps taken to assign differentiating voices to speakers and generate a narrative audio work using the assigned differentiating voices;

FIG. 5 is an exemplary flowchart showing one example of steps taken in adjusting voice properties to differentiate a first voice over a second voice;

FIG. 6 is an exemplary diagram depicting one example of a user interface that enables a user to adjust voice acoustic properties;

FIG. 7 is a block diagram of a data processing system in which the methods described herein can be implemented; and

FIG. 8 provides an extension of the information handling system environment shown in FIG. 7 to illustrate that the methods described herein can be performed on a wide variety of information handling systems which operate in a networked environment.

### DETAILED DESCRIPTION

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions. The following detailed description will generally follow the summary of the disclosure, as set forth above, further explaining and expanding the definitions of the various aspects and embodiments of the disclosure as necessary.

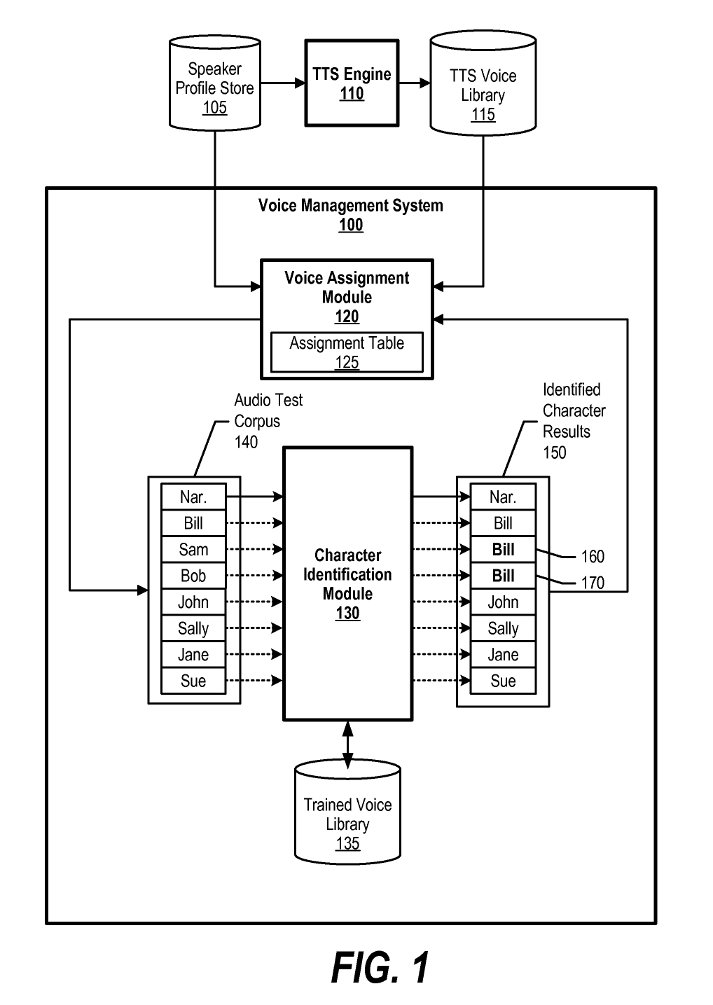

FIG. 1 is a diagram showing one example of a voice management system that assigns text-to-speech (TTS) voices to characters in a narrative work and re-assigns different TTS voices to characters when initial TTS voices are not uniquely discernable from other TTS voice.

Voice management system 100 includes voice assignment module 120, which assigns TTS voices to characters based upon the characters' character profile parameters (e.g., age, gender, regional accent, etc.). As defined herein, a character may be a narrator or a character within a narrative work, where a narrative work is a work of literature (e.g., books, articles, etc.), a co-worker speaking via computer-mediated dialogue (e.g., automated translation services), a person provided with a synthetic voice due to speaking disabilities, a computer gaming scenario, or other situations that utilizes synthesized voices.

Character profile store 105 includes a list of character profiles, such as a list of characters and a narrator in a narrative work, such as each character's gender, age, regional accent, etc. In one embodiment, voice assignment module 120 analyzes each of the character profiles and assigns an initial TTS voice to each character profile based upon pre-defined voices stored in TTS voice library 115. In another embodiment, TTS engine 110 generates new voices based upon the character profiles and adds the new voices to TTS voice library 115. In this embodiment, voice assignment module 120 retrieves the new voices and assigns the new voices to the characters.

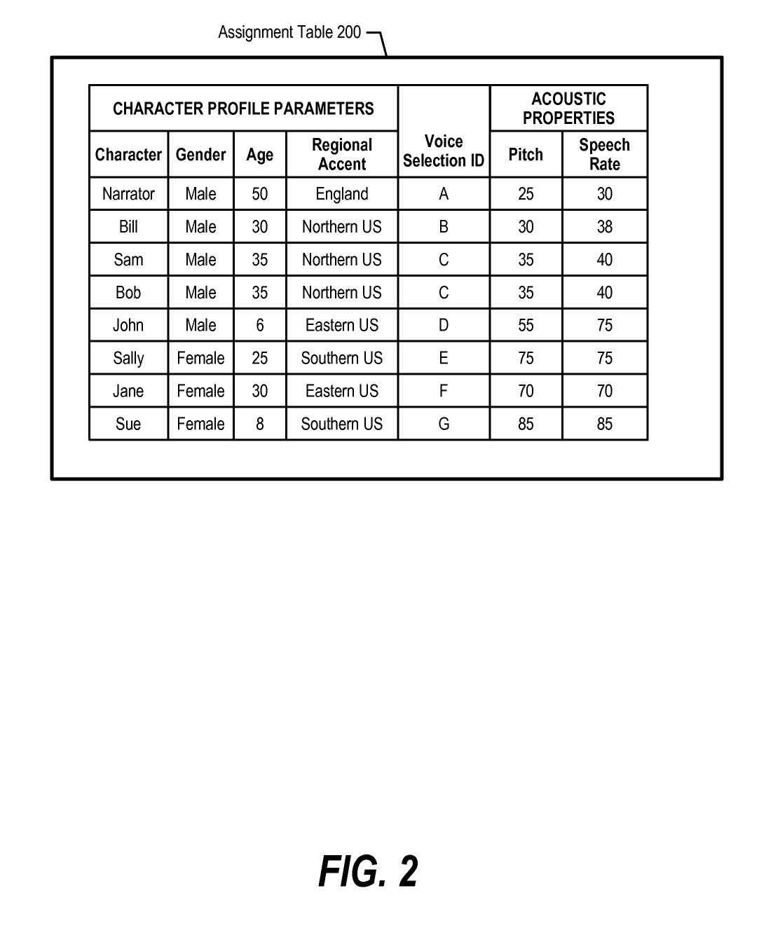

Voice assignment module 120 logs the assigned voices to the characters in assignment table 125 and builds an audio corpus that includes a set of audio recordings for each character using the assigned TTS voices (see FIG. 2 and corresponding text for further details). In one embodiment, voice assignment module 120 selects a list of literary elements from the narrative work and uses the selected voices to “read” a character's corresponding literary elements. In turn, voice assignment module 120 partitions the audio corpus into an audio train corpus and an audio test corpus. In one embodiment, the audio train corpus may include a large number of the audio recordings (e.g., 70%) and include multiple audio recordings corresponding to each character.

Voice assignment module 120 provides the audio train corpus to character identification module 130 (e.g., a speaker identification module), which character identification module 130 utilizes to “learn” the different character's voices (not shown). In one embodiment, character identification module 130 computes an “acoustic vector” for each character that includes a set of mel-frequency cepstrum (MFC) coefficients. In this embodiment, character identification module 130 stores the acoustic vectors as sets of acoustic properties in trained voice library 135. Acoustic properties may include pitch levels, speech rates, regional accents, timbres, registers, tones, or other phonetic properties that distinguish a character's voice. In one embodiment, character identification module 130 includes a vector quantizer that encodes the acoustic vectors into codebooks.

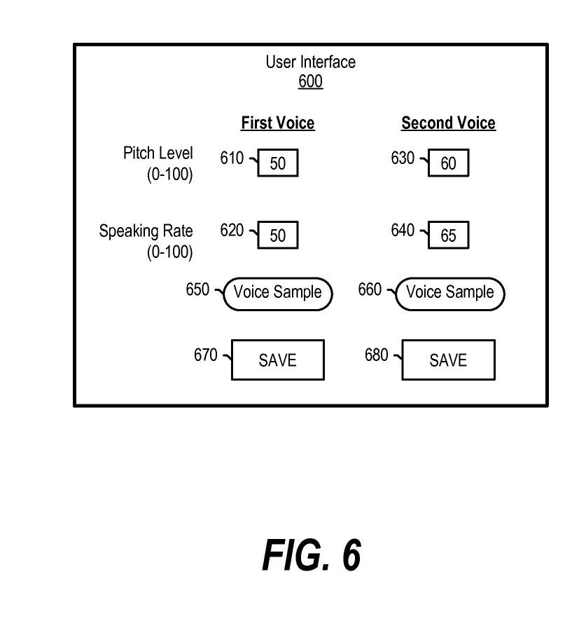

Once character identification module 130 completes voice training, voice assignment module 120 provides audio test corpus 140 to character identification module 130 that includes audio recordings of various characters. Character identification module 130 analyzes each audio recording in audio test corpus 140 and assigns a character identifier to each audio recording (identified character results 150). In one embodiment, character identification module 130 compares acoustic properties of the audio test corpus with the trained acoustic vectors to determine an accurate match. In this example, character identification module 120 may assign an incorrect character identifier to an audio recording when different acoustic vectors for different characters have similar properties (e.g., MFC coefficients) and are not within an acoustic differentiation threshold. FIG. 1 shows that character identification module 130 assigned incorrect character identifiers to audio recordings 160 and 170. As discussed herein, an acoustic differentiation threshold may be an absolute value (e.g., 30 Hz), or a subjective indication from a user that manually listens to different voices (see FIG. 6 and corresponding text for further details).

Voice assignment module 120 receives identified character results 150 and proceeds through an evaluation stage to determine whether the selected voice assignments are uniquely discernable by comparing character identification module 130's results with the expected results.

Voice assignment module 120 provides several solution options when voice assignment module 120 identifies a non-differentiable voice that cause character identification module 130 to identify an incorrect character. Voice assignment module 120 analyzes acoustic properties of the character's intended voice and the incorrectly identified voice. For example, voice assignment module 120 may have assigned a voice to “Sam” that has a relative pitch of 35 and a relative speech rate of 40. In this example, character identification module 130 may have mistaken Sam's audio recording as a different character (Bill) that has a relative pitch of 30 and a relative speech rate of 38.

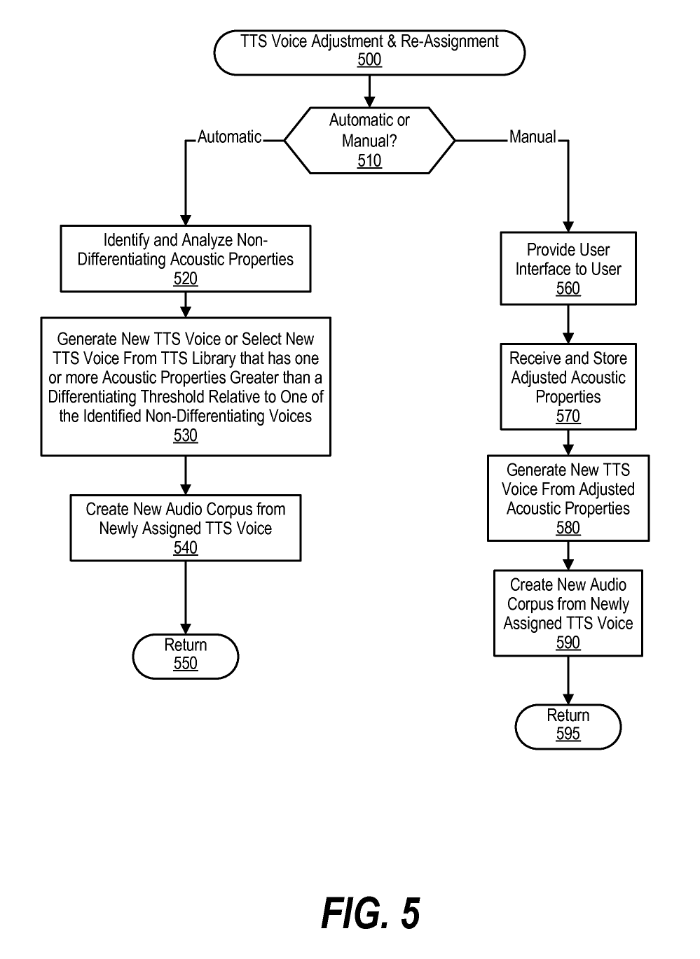

In turn, voice assignment module 120 accesses TTS voice library 115 to select a different pre-defined TTS voice that has higher/lower relative pitch and/or relative speech rate. In one embodiment, voice assignment module 120 provides a user interface to a user and allows the user to adjust voice parameters until the non-differentiable voice is different than the other character voices (see FIGS. 5, 6, and corresponding text for further details). Once voice assignment module 120 determines that the assigned TTS voices are acceptable, voice management system 100 generates a narrative audio work utilizing the assigned TTS voices.

FIG. 2 is a diagram depicting one example of an assignment table that includes initial voice assignments for various characters. Prior to training character identification module 130, voice assignment module 120 generates character profile parameters for each character through various means such as by evaluating a narrative work and/or user entry. In turn, voice assignment module 120 assigns a voice to each of the characters based upon the character profile parameters and creates entries in assignment table 125 accordingly that match each character to a particular voice. Assignment table 200 shows that voice assignment module 120 assigns voice “C” to both Sam and Bob due to their similar character profile parameters.

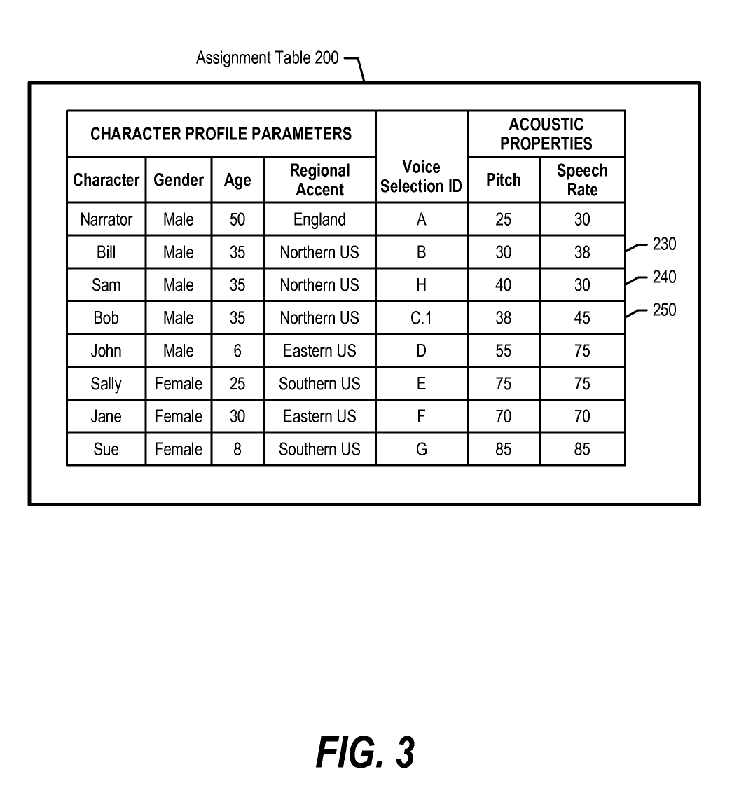

FIG. 3 is a diagram depicting one example of an assignment table that includes revised voice assignments for various characters in response to voice assignment module 120 determining that character identification module 130 identified incorrect characters. FIG. 3 shows that voice assignment module 120 changes voice selections for Sam and Bob relative to those shown in FIG. 2. FIG. 3 shows that voice assignment module 120 assigns voice “H” to Sam, which has a higher relative pitch than voice B and is discernable over voice B. Voice assignment module 120 assigns voice “C.1” to Bob, which is a customized version of voice C, for example, from a user utilizing user interface 600 shown in FIG. 6.

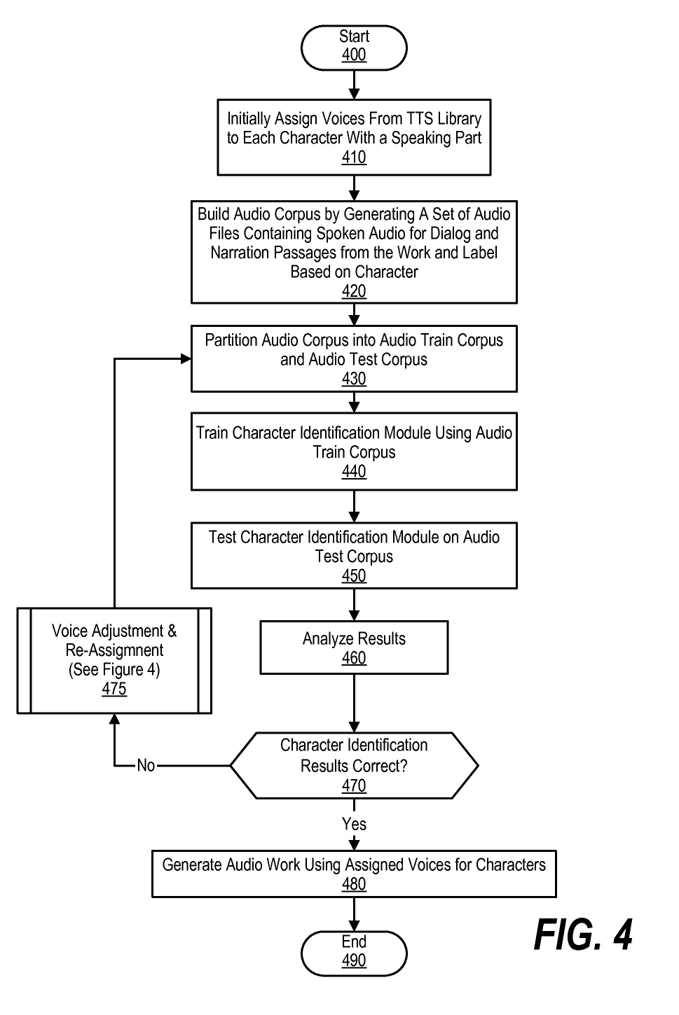

FIG. 4 is an exemplary flowchart showing one example of steps taken to assign differentiating voices to characters and generate a narrative audio work using the assigned differentiating voices. Processing commences at 400, whereupon a voice assignment module assigns initial voices to characters in a narrative work according to parameters of the individual characters, such as male, age 35, English heritage, etc. (410). In one embodiment, the voice assignment module selects pre-defined voices from a library. In another embodiment, a TTS engine creates the voices from the character's character profile parameters.

At 420, the voice assignment module builds an audio corpus that includes a set of audio files for each character, such as by using dialog included in the narrative work. The voice assignment module partitions the audio corpus into an audio train corpus and an audio test corpus. In one embodiment, the audio train corpus may include 70% of the content included in the overall audio corpus and include multiple audio files corresponding to each character.

The voice assignment module provides the audio train corpus to a character identification module, which the character identification module utilizes to learn the different voices. For example, an audio file may include a voice tag of “Bob” and the character identification module analyzes the audio file and creates a codebook that corresponds to character Id=“Bob”. As such, when the character identification module, running in test mode, receives a voice pattern whose quantized properties are more similar to the entry for Bob than for any of the other characters in the work, the character identification module identifies Bob as speaking the test audio sequence.

Once the character identification module completes voice training, the voice assignment module provides the audio test corpus to the character identification module. The character identification module, at 450, analyzes each audio file in the audio test corpus and assigns a character to each audio file (identified character results 140). The voice assignment analyzes the results at 460, and the voice assignment module determines whether the character identification results are correct (decision 470). As can be seen in the example shown in FIG. 1, character identification module 130 misidentifies Sam and Bob's audio test corpus as Bill.

If one or more of the audio files is not identified correctly, decision 470 branches to the “No” branch, whereupon the voice assignment module analyzes acoustic properties of the mismatched voices and assigns a different voice to a character accordingly (pre-defined process block 475, see FIG. 4 and corresponding text for further details). In one embodiment, the voice assignment module provides a user interface to a user for the user to adjust acoustic properties of the voice based upon listening preference (see FIG. 6 and corresponding text for further details). In another embodiment, the user interface presents a summary of errors generated during the character identification test.

This looping continues until the character identification module correctly identifies each of characters, at which point decision 470 branches to the “Yes” branch, whereupon processing generates narrative audio work (e.g., an audio book) using the assigned voices (480), and processing ends at 490. In one embodiment, the voice assignment module imposes stricter thresholds for completing the voice assignment process (e.g., generating a confidence level value above a threshold).

FIG. 5 is a flowchart showing one example of steps taken in adjusting voice properties to differentiate a first voice over a second voice. Processing commences at 500, whereupon processing determines whether to automatically change a voice or to manually adjust voice parameters of a voice based on, for example, user preferences (decision 510). If processing should automatically change a voice selection, decision 510 branches to the “automatic” branch, whereupon processing analyzes non-differentiating acoustic properties, such as two voices having near identical pitch or speech rates (520). At 530, processing generates a new TTS voice, or selects a new TTS voice from the TTS library, that has acoustic properties greater than a differentiating threshold compared with acoustic properties of a misidentified voice. For example, a pitch differentiation threshold may be 30 Hz and, in this example, the voice assignment module creates a new voice that has a pitch 30 Hz higher than the misidentified voice. Processing creates a new audio corpus from the new TTS voice (540), and returns at 550 to re-train the character identification module and re-test the audio corpus.

On the other hand, if processing should manually adjust the voice properties, decision 510 branches to the “Manual” branch, whereupon processing provides a user interface to a user at 560, such as user interface 600 shown in FIG. 6. At 570, processing receives and stores the user's adjusted acoustic properties. Processing generates a new TTS voice based upon the adjusted acoustic properties at 580, such as increasing/decreasing voice pitch and/or speech rate. Processing creates a new audio corpus from the new TTS voice at 590, and returns at 595 to re-train the character identification module and re-test the audio corpus.

FIG. 6 is a diagram depicting one example of a user interface that enables a user to adjust synthetic voice acoustic properties. User interface 600 allows a user to adjust acoustic properties between two voices and listen to sample speech to determine whether the two voices are discernable.

In one embodiment, voice assignment module 120 populates entries 610 and 620 with initial acoustic properties of a first voice (e.g., voice B) and populates entries 630 and 640 with initial acoustic properties of a second voice (e.g., voice C). A user may then adjust the acoustic properties in such entries to differentiate the first voice from the second voice. The user may depress selection buttons 650 and 660 to hear a sample of the first voice and the second voice, respectively, according to the adjusted acoustic properties. When the user finishes adjusting the voice parameters, the user depresses buttons 670 and/or 680 to save the adjusted acoustic properties. In turn, the voice assignment module uses the adjusted voice in a new audio corpus for training and re-testing.

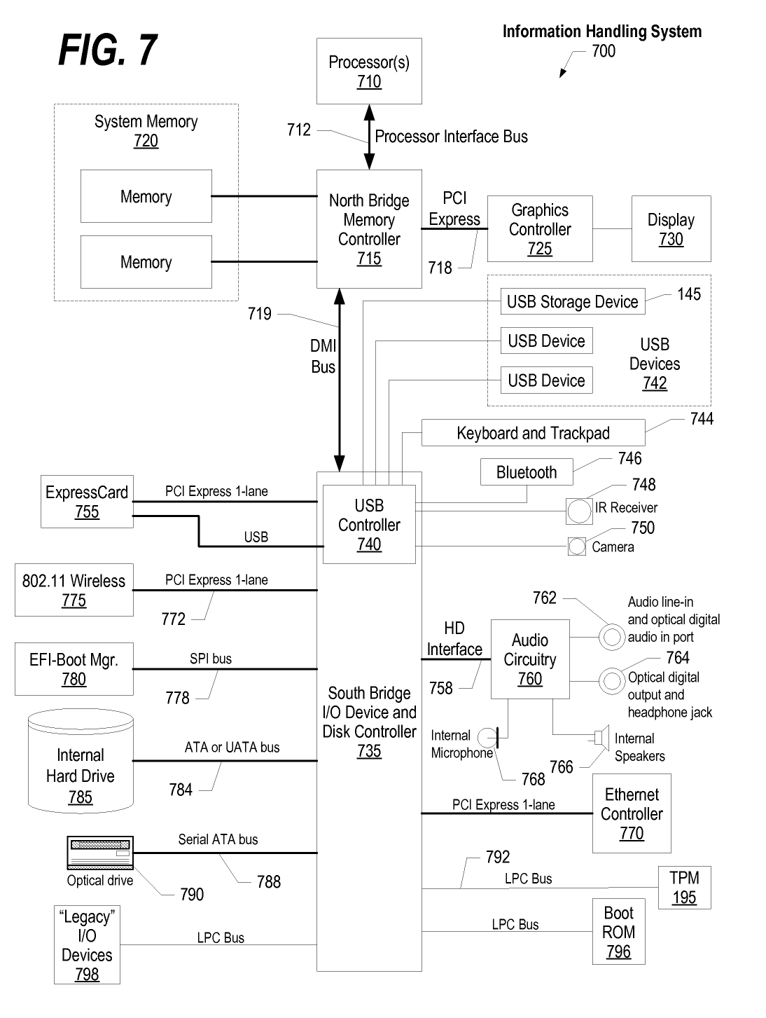

FIG. 7 illustrates information handling system 700, which is a simplified example of a computer system capable of performing the computing operations described herein. Information handling system 700 includes one or more processors 710 coupled to processor interface bus 712. Processor interface bus 712 connects processors 710 to Northbridge 715, which is also known as the Memory Controller Hub (MCH). Northbridge 715 connects to system memory 720 and provides a means for processor(s) 710 to access the system memory. Graphics controller 725 also connects to Northbridge 715. In one embodiment, PCI Express bus 718 connects Northbridge 715 to graphics controller 725. Graphics controller 725 connects to display device 730, such as a computer monitor.

Northbridge 715 and Southbridge 735 connect to each other using bus 719. In one embodiment, the bus is a Direct Media Interface (DMI) bus that transfers data at high speeds in each direction between Northbridge 715 and Southbridge 735. In another embodiment, a Peripheral Component Interconnect (PCI) bus connects the Northbridge and the Southbridge. Southbridge 735, also known as the I/O Controller Hub (ICH) is a chip that generally implements capabilities that operate at slower speeds than the capabilities provided by the Northbridge. Southbridge 735 typically provides various busses used to connect various components. These busses include, for example, PCI and PCI Express busses, an ISA bus, a System Management Bus (SMBus or SMB), and/or a Low Pin Count (LPC) bus. The LPC bus often connects low-bandwidth devices, such as boot ROM 796 and “legacy” I/O devices (using a “super I/O” chip). The “legacy” I/O devices (798) can include, for example, serial and parallel ports, keyboard, mouse, and/or a floppy disk controller. The LPC bus also connects Southbridge 735 to Trusted Platform Module (TPM) 795. Other components often included in Southbridge 735 include a Direct Memory Access (DMA) controller, a Programmable Interrupt Controller (PIC), and a storage device controller, which connects Southbridge 735 to nonvolatile storage device 785, such as a hard disk drive, using bus 784.

ExpressCard 755 is a slot that connects hot-pluggable devices to the information handling system. ExpressCard 755 supports both PCI Express and USB connectivity as it connects to Southbridge 735 using both the Universal Serial Bus (USB) the PCI Express bus. Southbridge 735 includes USB Controller 740 that provides USB connectivity to devices that connect to the USB. These devices include webcam (camera) 750, infrared (IR) receiver 748, keyboard and trackpad 744, and Bluetooth device 746, which provides for wireless personal area networks (PANs). USB Controller 740 also provides USB connectivity to other miscellaneous USB connected devices 742, such as a mouse, removable nonvolatile storage device 745, modems, network cards, ISDN connectors, fax, printers, USB hubs, and many other types of USB connected devices. While removable nonvolatile storage device 745 is shown as a USB-connected device, removable nonvolatile storage device 745 could be connected using a different interface, such as a Firewire interface, et cetera.

Wireless Local Area Network (LAN) device 775 connects to Southbridge 735 via the PCI or PCI Express bus 772. LAN device 775 typically implements one of the IEEE 802.11 standards of over-the-air modulation techniques that all use the same protocol to wireless communicate between information handling system 700 and another computer system or device. Optical storage device 790 connects to Southbridge 735 using Serial ATA (SATA) bus 788. Serial ATA adapters and devices communicate over a high-speed serial link. The Serial ATA bus also connects Southbridge 735 to other forms of storage devices, such as hard disk drives. Audio circuitry 760, such as a sound card, connects to Southbridge 735 via bus 758. Audio circuitry 760 also provides functionality such as audio line-in and optical digital audio in port 762, optical digital output and headphone jack 764, internal speakers 766, and internal microphone 768. Ethernet controller 770 connects to Southbridge 735 using a bus, such as the PCI or PCI Express bus. Ethernet controller 770 connects information handling system 700 to a computer network, such as a Local Area Network (LAN), the Internet, and other public and private computer networks.

While FIG. 7 shows one information handling system, an information handling system may take many forms. For example, an information handling system may take the form of a desktop, server, portable, laptop, notebook, or other form factor computer or data processing system. In addition, an information handling system may take other form factors such as a personal digital assistant (PDA), a gaming device, ATM machine, a portable telephone device, a communication device or other devices that include a processor and memory.

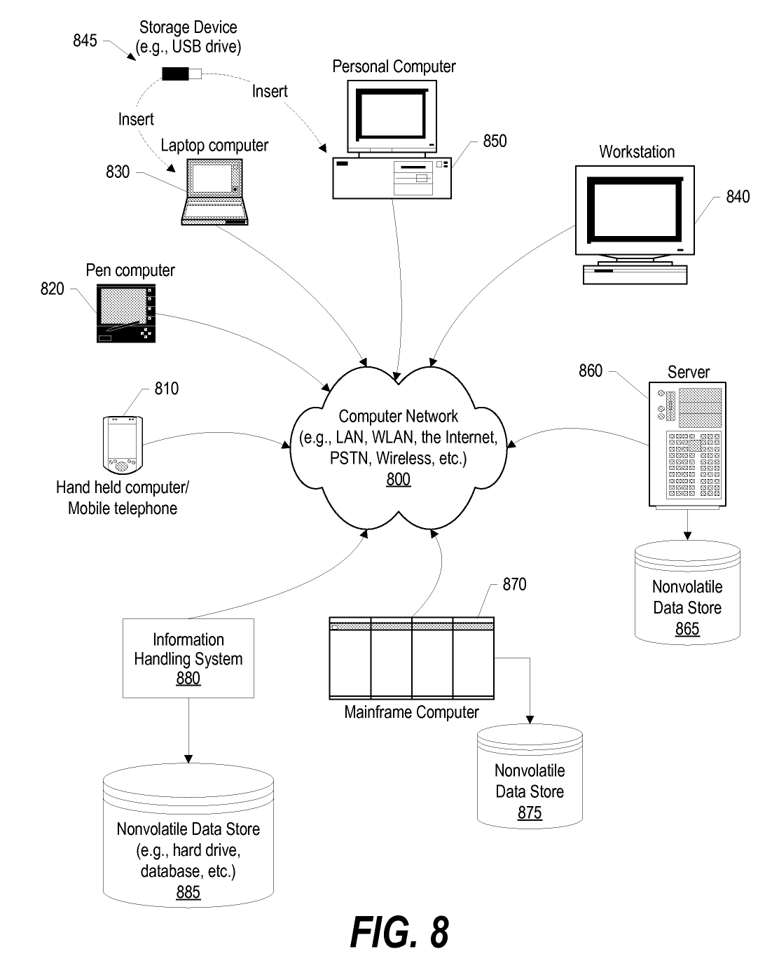

The Trusted Platform Module (TPM 795) shown in FIG. 7 and described herein to provide security functions is but one example of a hardware security module (HSM). Therefore, the TPM described and claimed herein includes any type of HSM including, but not limited to, hardware security devices that conform to the Trusted Computing Groups (TCG) standard, and entitled “Trusted Platform Module (TPM) Specification Version 1.2.” The TPM is a hardware security subsystem that may be incorporated into any number of information handling systems, such as those outlined in FIG. 8.

FIG. 8 provides an extension of the information handling system environment shown in FIG. 7 to illustrate that the methods described herein can be performed on a wide variety of information handling systems that operate in a networked environment. Types of information handling systems range from small handheld devices, such as handheld computer/mobile telephone 810 to large mainframe systems, such as mainframe computer 870. Examples of handheld computer 810 include personal digital assistants (PDAs), personal entertainment devices, such as MP3 players, portable televisions, and compact disc players. Other examples of information handling systems include pen, or tablet, computer 820, laptop, or notebook, computer 830, workstation 840, personal computer system 850, and server 860. Other types of information handling systems that are not individually shown in FIG. 8 are represented by information handling system 880. As shown, the various information handling systems can be networked together using computer network 800. Types of computer network that can be used to interconnect the various information handling systems include Local Area Networks (LANs), Wireless Local Area Networks (WLANs), the Internet, the Public Switched Telephone Network (PSTN), other wireless networks, and any other network topology that can be used to interconnect the information handling systems. Many of the information handling systems include nonvolatile data stores, such as hard drives and/or nonvolatile memory. Some of the information handling systems shown in FIG. 8 depicts separate nonvolatile data stores (server 860 utilizes nonvolatile data store 865, mainframe computer 870 utilizes nonvolatile data store 875, and information handling system 880 utilizes nonvolatile data store 885). The nonvolatile data store can be a component that is external to the various information handling systems or can be internal to one of the information handling systems. In addition, removable nonvolatile storage device 745 can be shared among two or more information handling systems using various techniques, such as connecting the removable nonvolatile storage device 745 to a USB port or other connector of the information handling systems.

While particular embodiments of the present disclosure have been shown and described, it will be obvious to those skilled in the art that, based upon the teachings herein, that changes and modifications may be made without departing from this disclosure and its broader aspects. Therefore, the appended claims are to encompass within their scope all such changes and modifications as are within the true spirit and scope of this disclosure. Furthermore, it is to be understood that the disclosure is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to disclosures containing only one such element, even when the same claim includes the introductory phrases “one or more” or “at least one” and indefinite articles such as “a” or “an”; the same holds true for the use in the claims of definite articles.

1. A method of utilizing differentiable synthetic character voices to generate a narrative audio work, the method comprising:
generating, by one or more processors, a plurality of audio test recordings utilizing a plurality of text-to-speech (TTS) voices, wherein each of the plurality of TTS voices correspond to a different set of acoustic properties, and wherein the plurality of audio test recordings are stored in a memory;
assigning a first TTS voice that corresponds to a first one of the plurality of audio test recordings to a first character, the first audio test recording included in the plurality of audio test recordings;
assigning a second TTS voice that corresponds to a second one of the plurality of audio test recordings to a second character in response to a determination that the second audio test recording reaches an acoustic differentiation threshold when compared to the first audio test recording; and
generating the narrative audio work utilizing the first TTS voice corresponding to the first character and the second TTS voice corresponding to the second character.

2. The method of claim 1 wherein, prior to the assignment of the second TTS voice, the method further comprises:
assigning a different TTS voice that corresponds to a different one of the plurality of audio test recordings to the second character;
determining that the different audio test recording does not reach the acoustic differentiation threshold when compared to the first audio test recording; and
performing the generation of the second audio test recording in response to the determination that the different audio test recording does not reach the acoustic differentiation threshold when compared to the first audio test recording.

3. The method of claim 2 wherein, subsequent to the generation of the second audio test recording, the method further comprises:
comparing a plurality of first acoustic properties corresponding to the first TTS voice to a plurality of second acoustic properties corresponding to the second TTS voice, resulting in a plurality of comparison results; and
performing the assignment of the second TTS voice in response to a determination that each of the comparison results reaches the acoustic differentiation threshold.

4. The method of claim 3 further comprising:
providing a user interface to a user that includes the plurality of first acoustic properties;
receiving one or more acoustic property changes from the user; and
storing the received one or more acoustic property changes as one or more of the plurality of second acoustic properties.

5. The method of claim 4 further comprising:
adjusting the acoustic differentiation threshold based upon the received one or more acoustic property changes.

6. The method of claim 3 wherein at least one of the plurality of first acoustic properties is selected from the group consisting of a pitch level, a speech rate, a regional accent, a timbre, a register, and a tone.

7. The method of claim 1 further comprising:
selecting the first TTS voice to assign to the first character based upon one or more first character profile parameters corresponding to the first character; and
selecting the second TTS voice to assign to the second character based upon one or more second character profile parameters corresponding to the second character.

8. An information handling system comprising:
one or more processors;
a memory coupled to at least one of the processors;
a set of computer program instructions stored in the memory and executed by at least one of the processors in order to perform actions of:
generating a plurality of audio test recordings utilizing a plurality of text-to-speech (TTS) voices, wherein each of the plurality of TTS voices correspond to a different set of acoustic properties, and wherein the plurality of audio test recordings are stored in a memory;
assigning a first TTS voice that corresponds to a first one of the plurality of audio test recordings to a first character, the first audio test recording included in the plurality of audio test recordings;
assigning a second TTS voice that corresponds to a second one of the plurality of audio test recordings to a second character in response to a determination that the second audio test recording reaches an acoustic differentiation threshold when compared to the first audio test recording; and
generating a narrative audio work utilizing the first TTS voice corresponding to the first character and the second TTS voice corresponding to the second character.

9. The information handling system of claim 8 wherein, prior to the assignment of the second TTS voice, at least one of the one or more processors perform additional actions comprising:
assigning a different TTS voice that corresponds to a different one of the plurality of audio test recordings to the second character;
determining that the different audio test recording does not reach the acoustic differentiation threshold when compared to the first audio test recording; and
performing the generation of the second audio test recording in response to the determination that the different audio test recording does not reach the acoustic differentiation threshold when compared to the first audio test recording.

10. The information handling system of claim 9 wherein, subsequent to the generation of the second audio test recording, at least one of the one or more processors perform additional actions comprising:
comparing a plurality of first acoustic properties corresponding to the first TTS voice to a plurality of second acoustic properties corresponding to the second TTS voice, resulting in a plurality of comparison results; and
performing the assignment of the second TTS voice in response to a determination that each of the comparison results reaches the acoustic differentiation threshold.

11. The information handling system of claim 10 wherein at least one of the one or more processors perform additional actions comprising:
providing a user interface to a user that includes the plurality of first acoustic properties;
receiving one or more acoustic property changes from the user; and
storing the received one or more acoustic property changes as one or more of the plurality of second acoustic properties.

12. The information handling system of claim 11 wherein at least one of the one or more processors perform additional actions comprising:
adjusting the acoustic differentiation threshold based upon the received one or more acoustic property changes.

13. The information handling system of claim 10 wherein at least one of the plurality of first acoustic properties is selected from the group consisting of a pitch level, a speech rate, a regional accent, a timbre, a register, and a tone.

14. The information handling system of claim 8 wherein at least one of the one or more processors perform additional actions comprising:
selecting the first TTS voice to assign to the first character based upon one or more first character profile parameters corresponding to the first character; and
selecting the second TTS voice to assign to the second character based upon one or more second character profile parameters corresponding to the second character.

15. A computer program product stored in a computer readable storage medium, comprising computer program code that, when executed by an information handling system, causes the information handling system to perform actions comprising:
generating a plurality of audio test recordings utilizing a plurality of text-to-speech (TTS) voices, wherein each of the plurality of TTS voices correspond to a different set of acoustic properties, and wherein the plurality of audio test recordings are stored in a memory;
assigning a first TTS voice that corresponds to a first one of the plurality of audio test recordings to a first character, the first audio test recording included in the plurality of audio test recordings;
assigning a second TTS voice that corresponds to a second one of the plurality of audio test recordings to a second character in response to a determination that the second audio test recording reaches an acoustic differentiation threshold when compared to the first audio test recording; and
generating a narrative audio work utilizing the first TTS voice corresponding to the first character and the second TTS voice corresponding to the second character.

16. The computer program product of claim 15 wherein, prior to the assignment of the second TTS voice, the computer program code, when executed by an information handling system, causes the information handling system to perform further actions comprising:
assigning a different TTS voice that corresponds to a different one of the plurality of audio test recordings to the second character;
determining that the different audio test recording does not reach the acoustic differentiation threshold when compared to the first audio test recording; and
performing the generation of the second audio test recording in response to the determination that the different audio test recording does not reach the acoustic differentiation threshold when compared to the first audio test recording.

17. The computer program product of claim 16 wherein, subsequent to the generation of the second audio test recording, the computer program code, when executed by an information handling system, causes the information handling system to perform further actions comprising:
comparing a plurality of first acoustic properties corresponding to the first TTS voice to a plurality of second acoustic properties corresponding to the second TTS voice, resulting in a plurality of comparison results; and
performing the assignment of the second TTS voice in response to a determination that each of the comparison results reaches the acoustic differentiation threshold.

18. The computer program product of claim 17 wherein the computer program code, when executed by an information handling system, causes the information handling system to perform further actions comprising:
providing a user interface to a user that includes the plurality of first acoustic properties;
receiving one or more acoustic property changes from the user; and
storing the received one or more acoustic property changes as one or more of the plurality of second acoustic properties.

19. The computer program product of claim 18 wherein the computer program code, when executed by an information handling system, causes the information handling system to perform further actions comprising:
adjusting the acoustic differentiation threshold based upon the received one or more acoustic property changes.

20. The computer program product of claim 17 wherein at least one of the plurality of first acoustic properties is selected from the group consisting of a pitch level, a speech rate, a regional accent, a timbre, a register, and a tone.
